(19) United States
(12) Patent Application Publication
(10) Pub. No.: US 2006/0235871 A1
(43) Pub. Date: Oct. 19, 2006

(54) Method and system for managing metadata information

(76) Inventors: James Trainor, Kitchener (CA); James Thomas Pike, Waterloo (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 11/405,597

(22) Filed: Apr. 18, 2006

Related U.S. Application Data
(60) Provisional application No. 60/672,097, filed on Apr. 18, 2005.

(51) Int. Cl. G06F 7/00

(52) U.S. Cl. 707/102

(57) ABSTRACT

A system for managing metadata information comprising a database for storing the metadata in formation; a central processing core, connected to the database, for monitoring and controlling access of the database; a process dispatcher for receiving the metadata information and transmitting the metadata information to the database via the central processing core; and a user interface for displaying the metadata information connected to the central processing core.

### CROSS REFERENCE TO RELATED APPLICATIONS

This application claims the benefit of priority of U.S. Provisional Patent Application No. 60/672,097 filed Apr. 18, 2005, which is incorporated herein by reference.

### FIELD OF THE INVENTION

The present invention relates generally to metadata information. More particularly, the present invention relates to a method and system for managing metadata information corresponding to a selected file, a group of files, users or processes.

### BACKGROUND OF THE INVENTION

In the world today, many individuals and companies are relying more and more on technology to operate their businesses. The use of computers and personal digital assistants have improved both communication between employees as well as the storage of company documents, stored as electronic, or computer files. Duties such as preparing documents, tracking documents and the organization of documents in a database are now very intertwined with technology. What used to be performed manually by humans may now be performed by a computer.

Along with being able to retrieve electronic documents from a database, individuals may also wish to view the properties, also known as metadata information, of these computer files. Modern file storage systems consist of files and directories. Metadata is generally something that is either attached to the file, embedded in the directory structure/names or resides in the operating system in the form of create/modified dates etc.

Metadata information includes, but is not limited to, the name of the file, the size of the file and/or the security of the file. Currently, some metadata information associated with a computer file is easily viewed by selecting and viewing the properties of the file, however, the metadata information is typically stored and displayed in a format designated by the platform on which the user is operating. Moreover, modern computer systems fail when large amounts of metadata information (or data about data) are required to be tracked, kept consistent over time and/or kept in sync with files being manipulated by different software packages. Metadata structures generally vary on a user-by-user basis and evolve over time. This evolution generally outpaces standards bodies and an ability of vendors to adapt.

It is, therefore, desirable to provide a novel method and system for managing metadata information, including viewing, manipulating and protecting.

### SUMMARY OF THE INVENTION

It is an object of the present invention to obviate or mitigate at least one disadvantage of previous methods and systems for managing metadata information.

In a first aspect of the invention, there is provided a system for managing metadata information comprising a database for storing the metadata information; a central processing core, connected to the database, for monitoring and controlling access of the database; a process dispatcher for extracting and generating metadata information and transmitting the metadata information to the database via the central processing core; and system, preferably a specialized file system interface, for displaying, protecting and manipulating the metadata information connected to the central processing core.

In another aspect, there is provided a system for managing metadata information comprising a database for storing said metadata information; a central processing core, connected to said database, for modelling and controlling data flowing in and out of said database; a process dispatcher for receiving said metadata information and transmitting said metadata information to said database via said central processing core; and a user interface for displaying, searching, altering, protecting, manipulating said metadata information connected to said central processing core.

In a further embodiment, there is provided a method of managing metadata information comprising the steps of receiving an electronic file containing metadata information; processing said electronic file and said metadata information; storing said processed metadata information in a persistence layer database; and storing said processed electronic file in a file database.

This is preferably performed in any application as selected by a user. In this system, the metadata information may be viewed and manipulated in multiple formats by multiple applications.

An embodiment of the invention extends the database and metadata information model and promotes metadata information to make it an equal component part of such a system. The system comprises data objects (files in this case) and metadata objects. This provides for a far more flexible representation of descriptive, structural and process metadata information.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a schematic diagram of a system for managing metadata information;

FIG. 1a is a schematic view of an object model;

FIG. 2 is an example of a user interface for interacting with said system of FIG. 1; and

FIG. 3 is a flowchart outlining a method of managing metadata information.

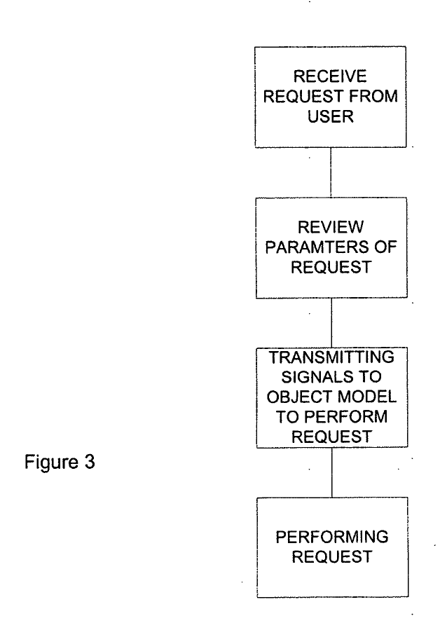

### DETAILED DESCRIPTION

Generally, the present invention provides a method and system for managing metadata information. The present invention is preferably housed and executed on a company intranet but may also be implemented over the Internet.

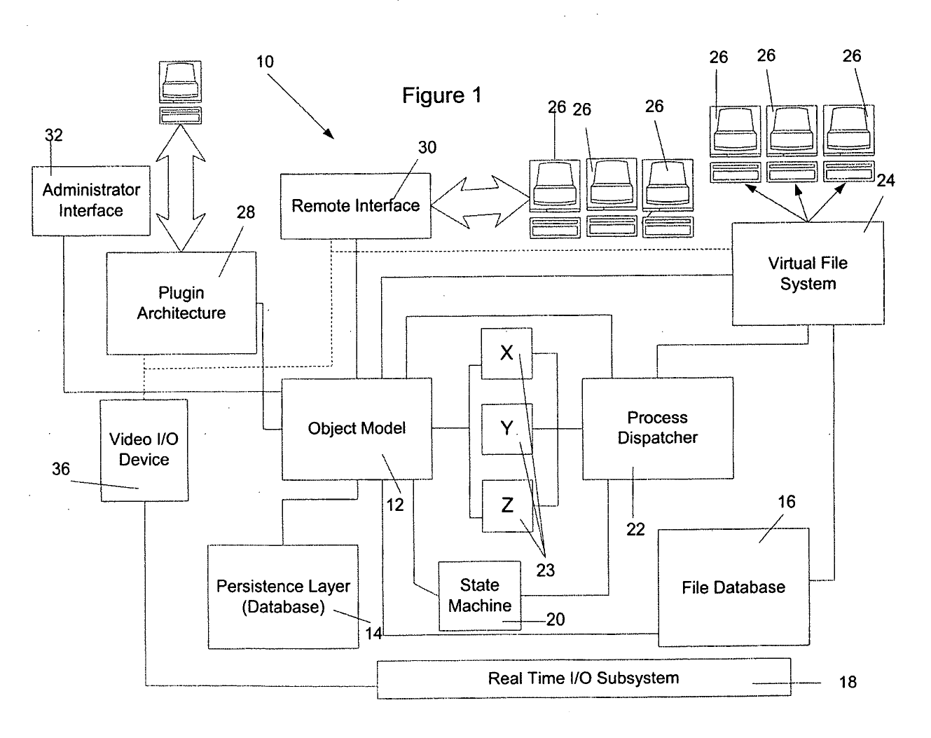

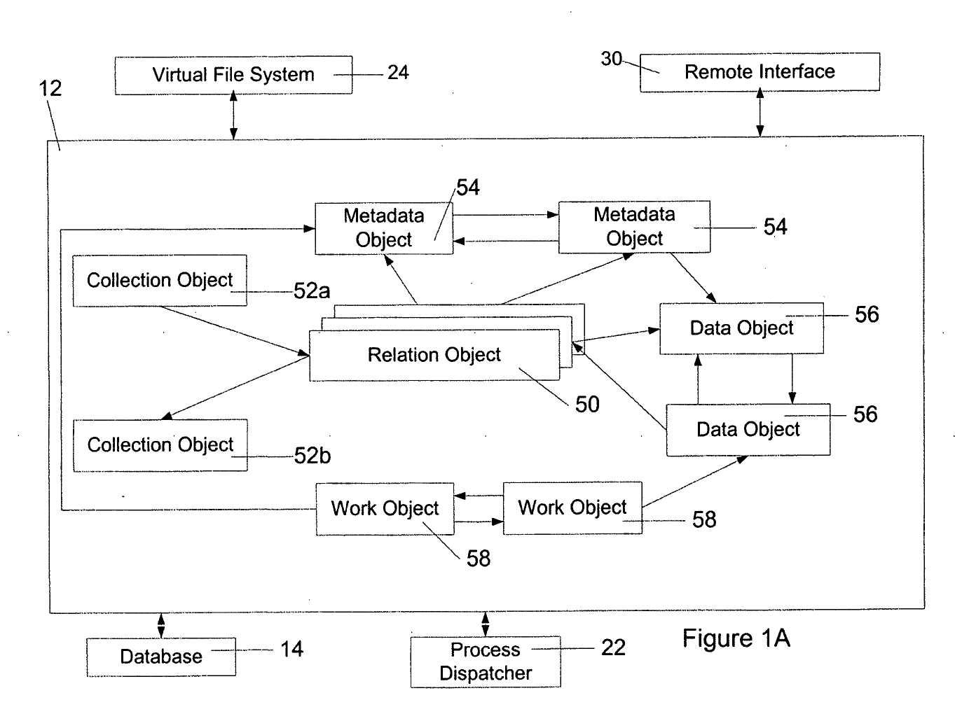

Turning to FIG. 1, a schematic diagram of an embodiment of a system for managing metadata information associated with the files for cooperative (programs that actively try to maintain metadata integrity) and non-cooperative (programs that routinely lose or incorrectly modify metadata) computer programs, or applications, is shown. The system may also handle/store a large number of electronic, or computer, files. Metadata information is generally seen as all of the properties associated with the essence or content of a computer file but does not include the content of the file. Metadata information is can be categorized in three groups: Descriptive, Structural or Operational. Examples of metadata information include, but are not limited to, the name of the file, the size of the file, the rights to the file, the security parameters of the file or information embedded in the file such as author, keywords etc. Structural metadata would include the order or sequence of files or relationships between files such as the association between the video and its related audio. Operational metadata would include information important to the processing of the files such as the last time a file was updated by a particular process.

The system manages metadata information and, preferably, their associated computer files allowing users to easily add, retrieve, review and manipulate this metadata information. The system displays the metadata information via an application on the user's display, which enables a user to manage the metadata information through a variety of mechanisms. The computer files may be stored together or separate from the metadata information in the system.

The system 10 comprises a framework, or object model, 12 which serves as a central data-modelling core for the entire system. The object model 12 may also be seen as a core processor for modelling and controlling metadata information. The object model 12 is connected to at least one persistence layer, also seen as a database, 14 that stores all of the metadata information corresponding to electronic, or computer, files in the system 10. A file database 16 for storing the electronic, or computer files is also preferably included in the system. It will be understood that the metadata information and the electronic files may all be stored in a single database. The file database 16 is connected to the object model 12 and a real-time I/O subsystem 18.

A state machine 20 is also located within the system 10 and is connected to the object model 12 and a processing dispatcher 22. As will be understood by one skilled in the art, the state machine 20 is a model of behavior composed of states, transitions and actions. A state stores information about the past, i.e. it reflects the input changes from the system start to the present moment. A transition indicates a state change and is described by a condition that would need to be fulfilled to enable the transition. An action is a description of an activity that is to be performed at a given moment. The state machine 20 provides a means for overseeing the processes running on the system to ensure that the processor operate correctly, as will be understood by one skilled in the art.

The process dispatcher 22 is connected directly to the object model 12 and indirectly via a set of software modules 23, whose operation will be further described below.

In general, the object model 12 is used to model persistent data or transactions against the persistent layer (database 14), support extensions and upgrades of a user's metadata model and the internal data models of the system and define an interface to the database 14. The object model 12 serves as the core to the system 10 and manages the files and their associated metadata information, whether a new file is being added or an existing file is being updated or displayed.

Turning to FIG. 1a, a more detailed schematic of an embodiment of a structure of the object model is shown. The object model 12 may also provide the functionality of an extendable object relational mapping to the persistence layer and an extensible dictionary which allows the object model to self describe the objects built up to accommodate a users specific and specialized metadata requirements.

The object model 12 comprises a set of relation objects 50 which serve as a connector between a set of collection objects 52, a set of metadata objects 54, a set of data objects 56 and a set of work objects 58. It will be understood that the set of relation objects 50, set of collection objects 52, set of metadata objects 54, set of data objects 56 and set of work objects 58 may include any number of objects and is not limited to the ones shown. Relation objects model the edge of a directed graph within the object model. Individual objects all contain information but their meaning and context is represented by through relations.

Each of the collection objects 52 may be connected to any one of the metadata objects 54, data objects 56 or another collection object 52, and vice versa, via one of the set of relation objects 50. The individual metadata objects 54, data objects 56 or work objects 58 may also be connected directly to one another or may be connected via a relation object 50. Metadata objects 54 may also be connected directly with other metadata objects 54, data objects 56 with data objects 56 and work objects 58 with work objects 58.

Each of the collection objects 52 preferably represents a directory of files within the system 10. For instance, one collection object 52a may represent a parent directory including directories and files while another collection object 52b may represent a second, or daughter, directory of files. Therefore, the parent directory collection object 52a is associated with the second, or daughter, directory collection object 52b via a relation object 50 so that this relationship is well-defined in the system. A data object 56 (representing an electronic file) is also associated to one of the directory collection objects via a relation object 50.

A virtual file system 24 and a remote interface 30 are individually connected to the object model 12 so that the user may interact with the system 10. When the virtual file system 24 accesses the system 10, the user is preferably prompted to select a directory of files for viewing. The collection object 52a corresponding to the selected directory is then retrieved from the database 14 and the information displayed to the user. The display may also include metadata objects 54 containing metadata information associated with the selected directory of files.

All of the objects (collection, metadata or data) associated (defined by relation objects 50 or by direct connection with each other) with the selected directory 52a are then preferably displayed in a directory format to the user. A metadata object 54 may also be displayed in the directory as a data object 56.

The set of data objects 56 are the fundamental information unit that is being managed by the object model 12 while the set of metadata objects 54 is used to represent descriptive, structure and process metadata information.

The descriptive metadata information is associated with a specific data object. The structure metadata information is information that describes how data objects are related to each other (for instance the Collection object). The process metadata information is information that describes the processes in which a data object is involved in processing (such as the work objects).

After accessing the requested file (data object), the user may then decide to save the amended or altered data object. As the data object is saved to the system 10, the process dispatcher 24 receives the saved file and transmits instructions to the work objects 58 (which may also represent a set of software modules 23) to process the data object being stored to perform functions such as retrieving updated metadata information from the amended data object.

The object model 12 generally provides referential integrity between the objects as each of the objects are uniquely identified. Referential integrity guarantees objects have valid reference to existing objects.

The virtual file system 24 serves as one possible interface between a user (seen as computer 26) and the system 10 and is connected, in communication, with the process dispatcher 22, the object model 12 and the file database 16.

The virtual file system 24 provides an interface to the persistence layer database 14 through the object model which abstracts the way the electronic files are listed to the user 26 thereby providing flexibility for representing not only the electronic files and metadata information but the relationships between them. The virtual file system 24 may also provide the functionality for searching the persistence layer database 14. For example, when the user 26 requests a search of a directory listing of electronic files, the system 10 displays the results of the search as objects in the directory such as “Spreadsheet files from fiscal 2003”. This allows for an easily accessible search within any file system interface. Furthermore, searching may be performed when a directory within the virtual file system 24 represents a field of metadata information such as a journalists name. Within a journalists directory various subdirectories exist each with a different journalist that occurs in the system. All files associated with a given journalist would be associated with the specific journalist directory. Even though the files would be distributed all over the system i.e. stored in various databases, the object model associates all these files with the journalist who worked on specific file and allows all the metadata information associated with the specific journalist to appear together in a display listing. This further functionality provides a method to organize files in many different ways and present them from an ordinary file system interface.

Another possible functionality of the virtual file system 24 is to enable the user to have more exposure to the metadata information in the database 14. As the system 10 has very broad flexibility on how it exposes metadata information about a particular file, electronic files may be mirrored, or imaged, in the virtual file system. An associated file in a virtual subdirectory may for example contains the metadata information for a file in a specific and different format. This allows programs (on the user's computer) to have complete access to complex metadata information without having to know how to directly access the original electronic file in the file database 16 thereby providing a simple way for the user to interact with the database without knowing anything more than basic file programming or even the use of a program that understands the mirrored file format. With respect to structural metadata information, such as a list of video clips that make up a video program, the virtual file system 24 may display this information in a virtual subdirectory that contains all the electronic files (corresponding to the video clips) that the video program refers to even if they are stored in separate databases. The abstraction by the virtual file system 24 is a different view on the organization of the electronic files making up the video program so that the electronic files may be viewed and organized based on structural relationships present in other electronic files.

Yet a further function of the virtual file system is preferably to load metadata information specifications. As metadata information specifications or schemas may be extremely large and complex, loading this metadata information into the system may be difficult. The virtual file system 24 may provide a virtual directory to process an electronic file to store the all the metadata information specifications. Processing several electronic files that represent the full range of metadata fields would also be an possible.

Another virtual file system 24 function may include prioritized input/output (I/O) directories. As the system 10 may accommodate the requirement of sustaining I/O operations at a specific rate (say for playback of realtime video), a directory may be created so that the system 10 provides a higher prioritized input/output to files which are being read or written so that access to real time I/O is available for applications on the computer 26.

Furthermore, the virtual file system 24 may provide a directory within the VFS where files would be processed according to system rules so that the metadata information may be screened or manipulated. The rules would preferably govern such things, but is not limited only to these rules, as: validating metadata integrity and completeness so that the user is alerted if action needed to be taken; compressing electronic files; screening for files which should not be in the system 10; and/or dictate how electronic files and metadata information should be stored and how long they should be kept in each type of storage.

The system 10 also preferably comprises a plug-in architecture module 28, a remote interface 30, an administrator interface 32 and the real time input/output subsystem 18.

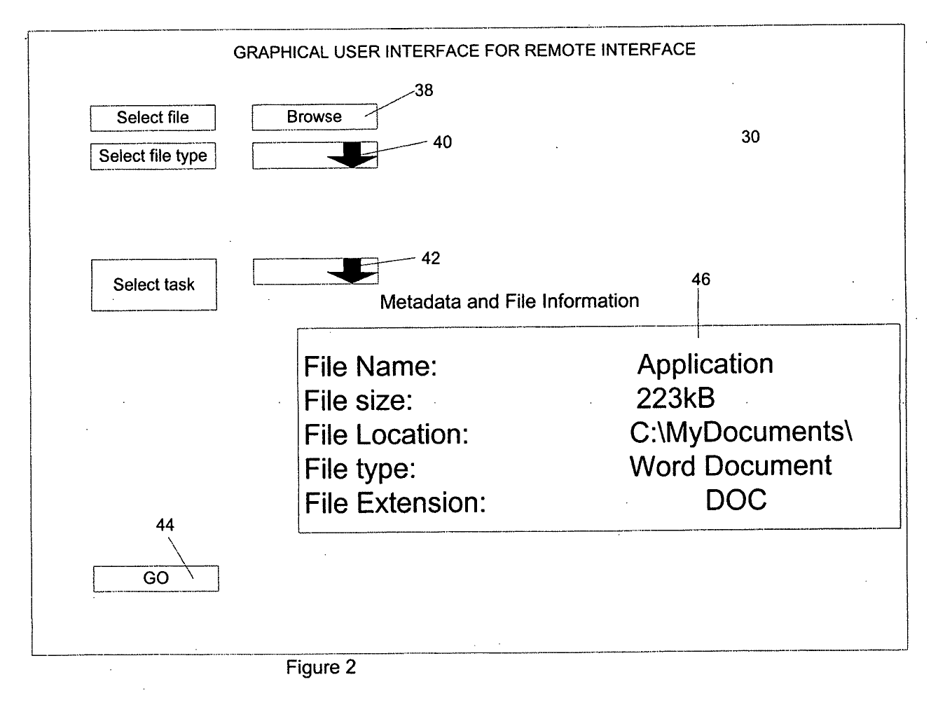

The remote interface 30 also provides an interface for a user to access the metadata information. The user accesses this metadata information via a graphical user interface (GUI) 34 (as shown in FIG. 2) which is displayed to a user on their computer 26. The GUI 34 provides functionality including searching, browsing, archiving, task management and project management for the metadata information as will be described below. The GUI 34 also allows for an array of onscreen images to be viewed providing a multireadhead playback device browsing of video files and provides an effective visual searching of media within a large group of files or distributed across one or more large files.

The administrator interface 32 allows secure access to the object model 12 and the databases 14 or 16 so that only selected individuals are able to configure and monitor the use of the object model 12 and, subsequently, system 10 to ensure that all interactions between a user and the system 10 are valid. Other functionality such as, but not limited to, maintenance of the system may also be performed via the administrator interface 32.

The plug-in architecture 28 allows a programmer (or an individual who is implementing the system 10) to provide further functionality for the system 10. For instance, if there is an application which is not supported by the system 10, a programmer may program the necessary code (preferably in the form of a module) and associate it with the plug-in architecture 28 so that when the plug-in architecture 28 is connected to the object model 12, a user is able to access the new code when they access the system via the remote interface 30 of the virtual file system 24. For instance, when a user requests the display of a computer file (or metadata information) in a non-supported, or non-cooperative, application, the information will be easily provided by the system to the user by the plug-in architecture which preferably includes the non-supported, or non-cooperative, application. Furthermore, this allows for flexibility for the system and allows the system to continually operate while a new module is being programmed rather than having to shut down the system 10 in order to update the system 10 to include the new module.

The real-time input output subsystem 18 provides prioritized streaming of files and video signals out of the system and prioritized recording and storing of incoming file streams and video signals into the system 10.

A video I/O device 36 may also be connected to the real-time input output subsystem 18 and the object model 12 to allow a user to play back and stream video files from and record to the system 10. The video I/O device 36 may also be connected to the plug-in architecture 28 (if installed), the remote interface 30 and the virtual file system 24 via control lines and/or data lines (video and audio) allowing control signals to be transmitted to and from the plug-in architecture 28, the remote interface 30 and the virtual file system 24. The I/O device 36 may also be used to record data as well.

In operation, when the user 26 is accessing the system 10 via the virtual file system 24 to store, or save, a new file in the system, the user 26 simply stores the file as if the system 10 is a normal network storage device. The user 26 accesses the virtual file system 24 via an interface which, in one embodiment, may be similar to a Windows Explorer™ type interface to interact through a regular file save/open dialog or through a file system tool on their own computer. The directory is displayed on the display of the user's computer.

It will be understood that although the present description describes the interaction between the system 10 and a single user, the virtual file system 22 (and the remote interface 30) may be concurrently accessed by multiple users.

When a user saves an electronic, or computer, file, the file is transmitted, via the virtual file system 22, to the process dispatcher 22 which reviews the file and then transmits a signal to the set of modules 23 which process the file in order to retrieve the metadata information from the file. The set of modules 23 may also be responsible for other file processing such as transforming metadata information, inserting metadata information, transcoding the file to other formats and generating links in the object model 12. This metadata information is then stored in the persistence layer database 14 while the file is preferably stored in the second database 16. The generated links preferably represent the relationship between the metadata information and the electronic file along with relationship(s) between the electronic file and other electronic files, metadata and objects in the system 10 which have been previously stored. This provides cross-referencing capabilities for all the files which are stored in the system 10.

When a user wishes to view the listing of electronic files in a directory on the system 10, the user calls up any file system interface, the interface communicates with the virtual file system 24) and the user selects the directory which they wish to review. A signal is then sent from the virtual file system 24 to the object model 12 to access the persistence layer database 14 for the listing of the files in the selected directory. The listing is provided in accordance with the previously stored metadata information. The object model 12 then retrieves the requested information (directory of files) from the database 14 and transmits this information to the virtual file system 24 for display to the user. After reviewing the directory, if the user 26 wishes to open a file, this request is transmitted to the virtual file system 24. The virtual file system 24 then determines the file which the user wishes to open and retrieves the requested file from the file database or dynamically generates the file from a file of a different format 16. The file is then opened (via the selected application) on the user's computer.

After the user is finished with the file and closes, or saves, the file back to the file database 16, the virtual file system 24 then transmits a signal to the process dispatcher 22 indicting that the user is finished with the file. The process dispatcher 22 then transmits at least one signal to the set of modules 23 to update, if necessary, the metadata information associated with the file. The modules 23 preferably read and parse the updated electronic file and extract the updated metadata information. The updated metadata information is then re-stored in the persistence layer database 14 and the updated file is stored in the file database 16. It will be understood that the electronic file may be stored in the file database 16 before the updated metadata information is stored in the persistence layer database 14. In addition the file may be reconverted back to its original format if the file was or dynamically generated.

The processor dispatcher 22 preferably also instructs the set of modules 23 to determine links or relationships between the updated file and other files and/or objects that are already stored in the system 10. These links and relationships are also stored in the persistence layer database 14 to enable cross-referencing between the electronic files. It will be understood that new links and updates to links between electronic files may occur after each file amendment, or update, and therefore, it is preferable that the relationships are updated each time the file is saved.

Once a file has been saved and the processes (executed by the set of modules 23 via instructions from the process dispatcher 18) have been completed, the file is available for reading from the file database 16 and different formats of the file are available through the virtual file system 24 and remote interface 30, while its metadata information is also available through both the virtual file system 24 and the remote interface 30.

In order to track the files which are stored in the file database 16, a directory list of files which are stored in the database 16 are dynamically generated from the database or is created/updated in the object model 12 so that when a user requests to view the metadata information of a previously stored file, the object model 12 may quickly retrieve the requested list of metadata information for display to the user.

In operation, when the user wishes to access the metadata information via the remote interface 30, the graphical user interface 34 is displayed on the user's computer.

The graphical user interface 34 preferably comprises of a set of tools for searching, browsing and manually entering metadata information, navigating file relationships, and managing tasks and projects. It will be understood that other functionality may be provided by the GUI 34 which assists a user in searching, managing, viewing, manipulating and protecting metadata information.

In the present embodiment, the graphical user interface 34 comprises means for selecting or entering a file name or search string 38 which allows the user to search for the files associated with the metadata information that the user wishes to retrieve or review. A means for selecting the type of file (i.e. file data type) 40, in the form of a drop down box, is also provided along with a means for selecting the type of action 42 to be performed on the file such as searching metadata information, viewing metadata information or amending metadata information. It will be understood that the drop down box is only one way of providing a list of options to a user and that others may be contemplated.

After the user has entered and selected the required properties or parameters, the user may depress a GO button 44 which causes the system 10 to retrieve the requested information and perform the selected task.

When a user wishes to view or amend metadata information corresponding to a file which has been previously stored in the file database 16, the user interacts with the graphical user interface 34 to enter the file name or other search criteria. After receiving the request (once the GO button 44 is depressed), a signal is transmitted from the remote interface 30 to the object model 12 requesting the object model 12 to confirm the presence of the metadata information in the persistence layer database 14 and to display the requested information. If the electronic file has not been previously stored (resulting in no metadata information available for display), a message indicating such is preferably displayed to the user, otherwise, the metadata information associated with the file, or a group of files, is retrieved from the persistence layer database 14 by the object model 12. After the object model 12 has retrieved this metadata information, the object model 12 transmits the information to the remote interface and the metadata information is displayed to the user via a display area 46 in the graphical user interface 34.

If the user wishes to amend or alter the metadata information, once the user is finished amending the metadata information, the user may save the update. Once the save is sensed by the GUI 34, a signal is transmitted from the remote interface 30 to the object model 12 to update the metadata information in the persistence layer database 14. The object model may dictate metadata or security rules when metadata changes are submitted to insure metadata integrity. All of the other files or metadata information which are linked to the amended metadata information are also updated to reflect the new amendments.

An advantage of the present invention is that existing electronic, or computer files, may be converted to other formats dynamically without requiring all formats to be generated and stored before they are requested. The system 10 provides a virtual directory for each possible conversion format. When a file is initially saved, the modules 23 preferably prepare a virtual directory for all possible formats in which the file may be displayed or opened by the user (generally via the virtual file system 24). The possible formats may optionally be generated and stored in the persistence layer database for performance reasons. 14. The object model 12 models the virtual directories using collection objects 52 and relation objects 50. It will be understood that other formats may be available via the plug-in architecture. When a user wishes to view a directory with respect to a file (via the virtual file system 24), these virtual directories are also displayed to the user such that if a user wishes to view the file (or metadata information) in one of the alternative formats (currently only virtual files), the user is able to view the virtual directory for that format along with the virtual file within the directory. Therefore, if the user wishes to open up the file in the alternative format, the file is created and appears in the user's application. When the user saves or closes the file, the processor dispatcher 22 transmits signals to the set of modules 23 to perform functions as extracting the new metadata information, inserting the new metadata information and generating links in the object model 12 for the electronic file saved in the new file format. This updated metadata information is then stored in the persistence layer database 14.

It will be understood that the database(s) 14 or 16 may be accessed directly or indirectly without having to interact with the virtual file system 24 or the remote interface 30, however all file and metadata requests are handled by the object model 12. Therefore, each time a file is amended, the object model 12 recognizes the amendment and updates the directory list to include the new metadata information. The object model 12 may also transmit signals to the modules 23 to update the current list of metadata information to reflect amendments to an electronic file. It should be understood that the object model and the database work to coordinate updates and requests such that the integrity of the system is maintained. {perhaps this should be moved earlier in the application}

With respect to the administrator interface 32, this interface allows specified users to adjust the security and overall settings of the system. The administrator interface 32 may also be accessed by users who have a password in order to maintain the security of the overall system 10. Via the administrator interface 32, the specified users may review the usage of the system on a per user basis, monitor the system for intruders or electronic hackers, perform regular maintenance to the system or to add users and groups, and add or remove modules 23 from the system 10. It will be understood that other functionality may also be provided via the administrator interface 32 to the users of the system.

The plug-in architecture 28 allows further functionality to be provided to the system 10 in a secure manner. Moreover, the architecture 28 allows software modules to be loaded on demand thereby saving memory for the overall system 10 that may be used for other applications. Also, the plug-in architecture 28 also allows for easy upgrades to the overall functionality of the system 10. For instance, if a company wishes to provide the capability for a user to view the listing of metadata information or electronic file using an unrecognized application, non-permanent modules may be coded and installed into the plug-in architecture so that when a user requests the listing of metadata information or electronic file in this unrecognized application, the system is able to provide the requested information. It will be understood that there are times when it would be more beneficial to update the system to include these modules but in times when the unrecognized application is simply a specialized internal application (whereby other companies would not have access or need for such modules), the provision of the plug-in architecture 28 allows for more memory to be available to the system for other requirements.

Depending on the size of the databases 14 or 16, it may be possible to store multiple versions or formats of the electronic files and multiple versions of the list of metadata information corresponding to versions of the files (for the different applications). However, if the database has a limited amount of space, it will be understood that new metadata information of the requested format may be created each time it is requested.

In an alternative embodiment, the user may perform a search for all files in the database 16 which include a specific string of characters. For instance, if a user wished to find all files corresponding to a CNN video, a search of CNN or *CNN* may be performed in order to retrieve all such files falling into this category. The user may then select a file for opening or for viewing the list of metadata information.

In yet another embodiment, the user may search the listing(s) of metadata information in the database for a specific string of characters and then select the file from a listing of the files in the display area of the graphical user interface of the virtual file system.

Alternatively, the virtual file system 24 may provide a single directory that is accessible for reading and writing files to many users 26. The directory provided to each individual user 26 is based on a predetermined distinguisher, or may be selected by the user, such as a User ID. The user id is used to uniquely identify the directory without the user being aware so that multiple users may access the same directory. Due to inherent problems with current naming conventions, multiple data objects in a directory may have the same file name and therefore, the UserID allows a user to have access to their version of the identically named data object. Currently, where there are two data objects with identical names and directory paths, there is a name collision with one of the data objects being over-written, and possibly deleted by the second data object. The advantage of this identification and sorting is that since many programs and devices work with a fixed directory structure and, as a result, have trouble handling multiple users working on same system sharing the same destination. This is especially true in the case where a standard directory is copied (possibly simultaneously) to the same network location. This is also true of processes that access the same network location.

The above-described embodiments of the present invention are intended to be examples only. Alterations, modifications and variations may be effected to the particular embodiments by those of skill in the art without departing from the scope of the invention.

What is claimed is:

1. A system for managing metadata information comprising:
at least one database for storing said metadata information;
a core processor; for modeling and controlling said metadata information stored in said at least one metadata database;
a process dispatcher for processing said metadata information and for transmitting said metadata information to said core processing for storing in said at least one database.

2. The system of claim 1 further comprising a user interface for receiving metadata information from and displaying metadata information to a user;

3. The system of claim 1 where said process dispatcher comprises a set of software modules for processing said metadata information

4. The system of claim 1 wherein said core processor is an object model.

5. The system of claim 1 wherein said user interface is a virtual file system

6. The system of claim 1 wherein said user interface allows a user to search, alter, protect and manipulate said metadata information.

7. The system of claim 1 wherein said at least one database stores electronic files associated with said metadata information.

8. The system of claim 1 further comprising a state machine.

9. The system of claim 1 further comprising a set of modules for processing said metadata information.

10. The system of claim 1 further comprising a file database for storing electronic files associated with said metadata information.

11. The system of claim 1 further comprising a real time I/O subsystem.

12. The system of claim 1 further comprising a video I/O device.

13. The system of claim 1 further comprising a plug-in architecture.

14. The system of claim 1 further comprising an administrator interface.

15. The system of claim 1 further comprising a remote interface.

16. A method of managing metadata information comprising the steps of:
receiving an electronic file containing metadata information;
processing said electronic file and said metadata information;
storing said processed metadata information in a persistence layer database; and
storing said processed electronic file in a file database.

17. The method of claim 16 wherein said file database is said persistence layer database.

18. The system of claim 4 wherein said object model comprises:
a set of collection objects;
a set of relation objects;
a set of metadata objects;
a set of data objects; and
a set of work objects.
